(19) United States
(12) Patent Application Publication
(10) Pub. No.: US 2013/0122463 A1
(43) Pub. Date: May 16, 2013

(54) METHOD AND SYSTEM FOR FACILITATING THE PLACEMENT OF A DENTAL IMPLANT

(71) Applicant: Raphael Yitz CSILLAG, ENGLEWOOD, NJ (US)

(72) Inventor: Raphael Yitz CSILLAG, ENGLEWOOD, NJ (US)

(21) Appl. No.: 13/678,020

(22) Filed: Nov. 15, 2012

Related U.S. Application Data
(60) Provisional application No. 61/559,990, filed on Nov. 15, 2011.

(51) Int. Cl. A61C 8/00; A61C 9/00; A61C 13/08

(52) U.S. Cl. CPC A61C 8/0089; A61C 13/08; A61C 9/00
USPC 433/173

(57) ABSTRACT

There is provided a method that includes (i) transmitting a signal, (ii) receiving (a) a first reflection of the signal from a first reflector on a dental appliance, and (b) a second reflection of the signal from a second reflector on a dental tool, and (iii) determining, from the first reflection and the second reflection, a position of the second reflector relative to the first reflector, thus yielding a relative position of the second reflector. There is also provided a system that performs the method.

### BACKGROUND OF THE INVENTION

1. Field of the Invention

The present disclosure relates to a surgical implant guidance system and method for assisting a clinician in optimal placement of a dental implant.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

Surgical placement of a dental implant is a very challenging procedure. Common factors that increase the degree of difficulty include; limitations in quality and/or quantity of bone, lack of access or visual restrictions, and avoidance of vital anatomical structures such as adjacent roots, inferior alveolar nerve, and the maxillary sinus to name a few.

Proper placement of an osteotomy for a dental implant is essential for success of a dental restoration retained by such an implant. The placement of the implant, including a linear position and angular positions, must properly correspond to a position of a subsequent future restoration. Creating the osteotomy in a correct position is difficult for multiple reasons. Aside from biologic danger, an improperly placed osteotomy can have significant negative side effects such as cosmetic, restorative, functional, hygienic, and patient comfort issues. Clinicians have long recognized this reality and its inherent risks, and as such, relatively few clinicians are able or willing to perform such an osteotomy.

There are several reasons why surgical placement of a dental implant is very challenging. A patient may present with limitations in quality and/or quantity of bone at a potential implant site. Additionally, during an actual procedure, vital anatomical structures, such as adjacent tooth roots, nerves, blood vessels and sinus cavities, must be avoided. Visual restrictions such as limited access due the patient's inability to open his or her jaw wide enough, bleeding and, or salivation, for example, obstruct the clinician's view during surgical placement, and make it that much more difficult.

Complications may arise from an improperly placed implant. An implant that is improperly placed by as little as a linear 1 mm or greater than 7° in angulation or inclination will also cause unwanted complications. Such an improper placement may result in major cosmetic loss of gingival papilla, longer or larger than normal sized teeth, shorter or smaller than natural sized teeth, or even mal-shaped teeth. In addition, a metal collar of the implant itself may be exposed in the patient's mouth, or the implant may be exposed if it is placed in an embrasure area between teeth.

An improperly placed implant may also lead to an undesirable hygienic issue that may, in turn, lead to peri-implantis, i.e., chronic periodontitis around the implant. A creation of a non-accessible area for proper hygiene will result in a plaque trap and an area of food impaction. Hygiene issues can lead to a chronic mal-odor and/or a foul taste in the mouth.

An implant that is improperly placed may also lead to a critical occlusal-loading complication due to a cantilevered restoration. A cantilevered restoration retained by the incorrectly placed implant can lead to loosening of cemented restorations, porcelain fracture, or even abutment screw and/or implant fractures.

Furthermore, improper implant placement can result in tongue crowding, cheek or lip chewing and speech impediments. Sensitivity may also result while or eating or brushing due to the implant's improper emergence through thin alveolar mucosa tissue that is non-keratinized.

When an implant is placed improperly yet is still is restorable, i.e., usable, a restorative dentist may use a custom abutment to restore the implant. This comes at an additional cost in the form of parts as well as laboratory labor.

However, an implant that has been improperly placed may not be restorable at all. In such a case, the non-restorable implant will either have to be buried under soft tissues in the gums or trephined out of the bone once it has been osseointegrated. Both of these scenarios pose extremely deleterious ramifications for the patient, which include the following. When the implant is buried under the soft tissue, exposure-related complications can result. In addition to the patient having to endure gingival augmentation procedures to prevent the implant from being exposed, overall retention and support of the restoration will be compromised, as it will now lack that additional abutment. Further, trephining the implant, i.e., surgical removal, from the bone introduces complications such as additional surgical procedures, which include their own inherent risks, additional bone grafting procedures, increased costs for grafting and regeneration material, increased healing time, and treatment time.

There exist several devices and methods designed to assist a clinician in the proper placement of an implant. Handmade surgical stents or guides are available in different shapes and forms to communicate a proper prosthetic placement to a dentist. Hand-made surgical stents are removable guides that may be made from acrylic or thermoplastic material. These stents/guides have drill slots or holes that help the clinician place the drill bit, i.e., surgical bur, in a location for the subsequent restoration.

However, surgical stents have many limitations. First, stents are time consuming to fabricate. Second, stents are not very accurate because the holes that are intended to guide the clinician are large and do not limit drill migration or tipping during osteotomy preparation. Migration impacts placement of the drill bit in the x-y, and z planes of space. Stents that offer smaller drill slots or holes cannot properly accommodate larger diameter drills.

Moreover, surgical stents are often cumbersome and may obstruct the clinician's vision. They may be difficult to work around and may become loose during drilling, particularly in the presence of a reflected gum flap. Surgical stents may not fit properly or may require additional work if there are adjacent teeth that serve as abutments holding a temporary bridge.

In the case of a completely edentulous patient, i.e., a patient having no teeth, stents often lack stability because of poor retention and support. In the case of such a patient, stability is a particular challenge because soft tissues do not prevent shifting or moving of the stents. Further, once the soft-tissue is reflected for surgical access to the bone, the already limited retention gets even worse.

Osteotomy drill positioning kits are another system that is designed to help place an implant in the bone of a patient. A drill kit is a pre-fabricated multi-piece kit that includes “blades”, i.e., metal perforated plates, for guiding the placement of one to two implants. The kit also includes removable guide pins with extensions to assist the clinician in placing the implants in a parallel fashion.

There are several limitations with drill positioning kits. First, they are limited to surgical cases of one to two implants, and are very expensive. Such kits consider only estimated linear position of the implant, and not the parameters of angulation, inclination or depth of penetration. Second, the small components pose an aspiration and a swallow risk, and must be held in place using an additional hand. Drill positioning kits require dental landmarks adjacent to the implant being placed, and therefore are essentially useless in complete edentulous cases or long span edentulous ridge cases.

More complicated systems exist that use lab-fabricated stereolithographic surgical guides. These CAD/CAM (i.e., computer-assisted design, computer-assisted milling) surgical stents are tooth or bone retained systems that provide the clinician the ideal drilling position with the help of metal tubes or sleeves that guide the positioning of the drill. The fabrication of stereolithographic surgical guides is based on a pre-operative computed tomography (CT) scan of the patient and pre-planning of implant placement on dental implant surgical software.

As with the other systems discussed, there are also limitations with this technology as well. Inaccuracies in the initial CT scan will translate to inaccuracies in the surgical stent.

Other drawbacks of stereolithographic surgical guides include an impediment of irrigation, i.e., coolant, from reaching the osteotomy site during drilling, which may contribute to an overheating of bone, and increased cell necrosis.

Another limitation includes the clinician's inability to make real-time changes based upon a current observation or situation. In a case of using a stent, the clinician is forced to use the metal sleeves/tubes provided within the stent. In addition, trans-crestal sinus augmentation may be very difficult to perform simultaneously while the stent is in place. Due to the size of the stents, the patient must also be able to open his/her mouth wide enough to accommodate longer drills, and multiple visits by the patient are required as treatment planning is lengthy and very involved. Additionally, the overall cost of this technology is much higher, as the clinician pays an additional lab fee for each stent that is fabricated.

Another system uses infra-red (IR) radar and IR sensors for real-time navigation, to guide a surgical hand piece in replicating a pre-planned surgical implant on a CT scan. This method is based on preliminary surgical planning with surgical implant software. Such a system requires that attachments be fixed to the surgical hand-piece, and the attachments are large and cumbersome due to the presence of the IR sensors. Further, an IR radar machine occupies a large footprint in the operatory and is extremely cost prohibitive.

While different systems and devices exist to help the clinician properly place implants, they have accuracy and cost shortcomings. Accordingly, there exists a need for a system and method that enables a clinician to effectuate a placement of a dental implant in an accurate, user-friendly manner that is not cost prohibitive.

### SUMMARY OF THE INVENTION

The present disclosure provides for a surgical implant guiding system that enables a user to replicate an implant placement in a patient's mouth. The user pre-measures or pre-plans the placement of the implant on one of (a) a model of the patient's jaw, (b) a CT scan of the patient's jaw, or (c) the patient's actual jaw.

The present disclosure also provides for a system that is compatible with a surgical implant hand piece to properly position an implant, and can be used during osteotomy site development, and actual implant placement.

Accordingly, there is provided a method that includes (i) transmitting a signal, (ii) receiving (a) a first reflection of the signal from a first reflector on a dental appliance, and (b) a second reflection of the signal from a second reflector on a dental tool, and (iii) determining, from the first reflection and the second reflection, a position of the second reflector relative to the first reflector, thus yielding a relative position of the second reflector.

The method also includes receiving a pitch of the dental tool and an inclination of the dental tool.

The method also includes storing, to a memory, the relative position, the pitch and the inclination.

The method also includes (a) comparing the relative position, the pitch and the inclination, to a stored relative position, a stored pitch and a stored inclination, respectively, and (b) providing, via a user interface, an indication of whether the relative position, the pitch and the inclination, match the stored relative position, the stored pitch and the stored inclination, respectively.

There is also provided a system that employs the method.

### BRIEF DESCRIPTION OF THE DRAWINGS

FIG. 1 is a block diagram of a system that guides a user to place a tool at a particular location, pitch and inclination.

FIG. 2 is a block diagram of an embodiment of a computer that is shown in FIG. 1.

FIGS. 3-6 are illustrations of a dental procedure for a surgical placement of a dental implant.

A component or a feature that is common to more than one drawing is indicated with the same reference number in each of the drawings.

### DESCRIPTION OF THE INVENTION

The present application discloses a dental procedure in which a user is guided by a computer to position a tool, e.g., a dentist drill, relative to a reference object that is located on a patient's jaw. The procedure includes:
(a) situating the reference object on the patient's jaw;
(b) measuring a position of the tool relative to the reference object, thus yielding a current relative position of the tool;
(c) measuring a current pitch of the tool and a current inclination of the tool;
(d) comparing the current relative position, the current pitch and the current inclination, to a stored relative position, a stored pitch and a stored inclination, respectively; and
(e) providing, via a user interface, an indication of whether the current relative position, the current pitch and the current inclination, match the stored relative position, the stored pitch and the stored inclination, respectively.

Radio detecting and ranging (RADAR) is a process whereby electromagnetic energy in the form of radio waves is transmitted, and reflections are measured using a receiver. These reflections are analyzed to provide information about objects in a path of the radio waves. A directive antenna is normally used in order to resolve the direction to a given object. Since radio waves travel at a predicable rate, the distance to the target can be estimated based on the round-trip delay of a pulsed signal. This process is quite similar to the reflection of sound off of a distant surface, the greater the distance, the greater the delay.

Ultra-Wideband (UWB) is a term for a classification of radio frequency (RF) signals that occupy a substantial bandwidth relative to their centre frequencies. UWB signals typically consist of very short pulses, e.g., a nanosecond or less, of energy separated by an amount of time much larger than the length of the pulse.

A phased array is an array of antennas in which relative phases of respective signals feeding the antennas are varied in such a way that effective radiation of the array is reinforced in a desired direction and suppressed in undesired directions. A phased array antenna is composed of a plurality of radiating elements each with a phase shifter. Beams are formed by shifting a phase of a signal emitted from each radiating element, to provide constructive/destructive interference so as to steer the beams in the desired direction. The physics behind phased arrays are such that the antenna is bi-directional, that is, it will achieve the same steerable pattern in a transmit mode as well as a receive mode. Thus, a phased array may be used to point a fixed radiation pattern, or to scan rapidly in azimuth and elevation.

An accelerometer is a device that measures non-gravitational accelerations. It is a 3-way axis device (i.e., x, y, and z axes) that is used to determine an object's orientation, that is, pitch, i.e., tilt left or right, and inclination, i.e., tilt forward or backward. The accelerometer can tell when the object is tilted, rotated, or moved. Orientation can also be measured with a gyroscope.

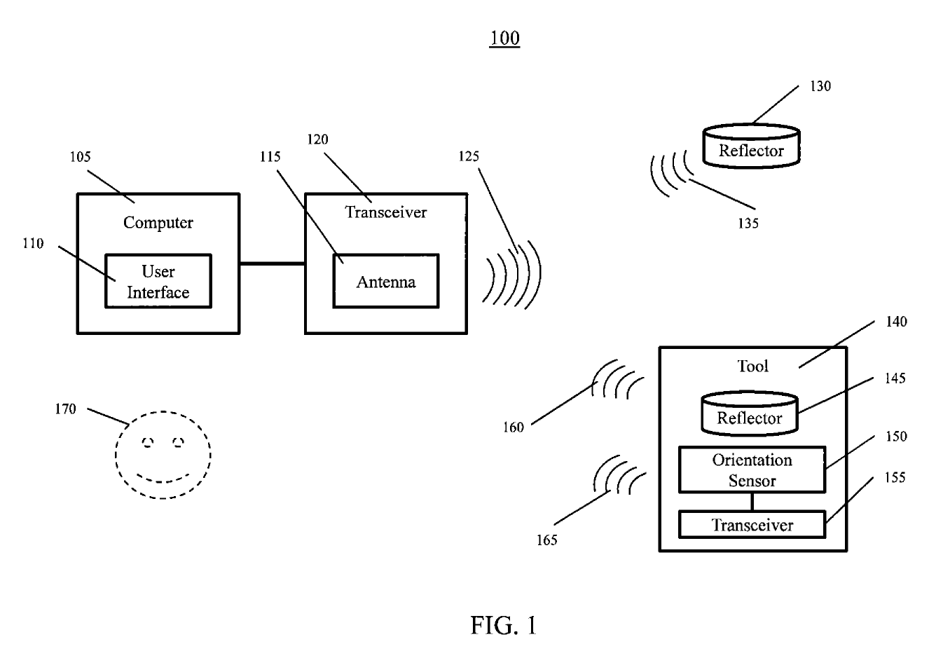

FIG. 1 is a block diagram of a system 100 that guides a user to place a tool at a particular location, pitch and inclination. System 100 employs RADAR and UWB technologies, and includes a computer 105, a transceiver 120, i.e., a transmitter/receiver, a reflector 130 and a tool 140. Computer 105 includes a user interface 110. Transceiver 120 includes a transmitter/receiver chipset pair (not shown) and an antenna 115.

Antenna 115 is a phased array antenna. Tool 140 includes a reflector 145, an orientation sensor 150, and a transceiver 155, i.e., a transmitter/receiver. Computer 105 and transceiver 120 work in cooperation with one another to determine a position and orientation of tool 140, and guide a user 170, by way of user interface 110, to position tool 140, or a device upon which tool 140 is situated, in a desired position.

Transceiver 120 transmits a UWB signal, i.e., a signal 125, via antenna 115. Each of reflectors 130 and 145 is configured of a material, e.g., a metal, that reflects a UWB RF signal, and in particular, signal 125. When signal 125 is incident on reflector 130, reflector 130 reflects signal 125 as a reflected signal 135. When signal 125 is incident on reflector 145, reflector 145 reflects signal 125 as a reflected signal 160. Via antenna 115, transceiver 120 receives reflected signal 135 and reflected signal 160.

Computer 105 receives reflected signal 135 and measures, and thus determines, a position of reflector 130. More specifically, computer 105 analyzes (a) the time between transceiver 120's transmission of signal 125 and receipt of reflected signal 135, to determine a distance between antenna 115 and reflector 130, and (b) an angle of arrival of reflected signal 135 at antenna 115, to determine an azimuth and elevation of reflector 130 with respect to antenna 115.

Computer 105 receives reflected signal 160 and measures, and thus determines, a position of reflector 145. More specifically, computer 105 analyzes (a) the time between transceiver 120's transmission of signal 125 and receipt of reflected signal 160, to determine a distance between antenna 115 and reflector 145, and (b) an angle of arrival of reflected signal 160 at antenna 115, to determine an azimuth and elevation of reflector 145 with respect to antenna 115.

Having determined the position of reflector 130 and position of reflector 145, computer 105 then determines, and thus effectively measures, the position of reflector 145 relative to reflector 130. For example, computer 105 can construct a 3-dimensional geospatial map in a coordinate system in which a point on antenna 115 serves as an origin, and in which reflectors 130 and 145 are situated. Given knowledge of the positions of reflectors 130 and 145 in that coordinate system, computer 105 can determine the position of reflector 145 relative to reflector 130, i.e., the relative position of reflector 145.

For example, assume an x, y, z coordinate system in which reflector 130 is located at a point 3, 4, 14, and reflector 145 is located at a point 4, 5, 13. The location of reflector 145 relative to reflector 130 would be (4-3), (5-4), (13-14)=1, 1, -1.

As mentioned above, tool 140 includes orientation sensor 150 and a transceiver 155 that is communicatively coupled to orientation sensor 150. Orientation sensor 150 is a device that senses a pitch of tool 140 and an inclination of tool 140, and may be implemented, for example, as an accelerometer or a gyroscope in a micro electro-mechanical system (MEMS). Transceiver 155 is an RF transmitter and an RF receiver, and communicates with transceiver 120. Transceiver 155 receives the pitch of tool 140 and the inclination of tool 140 from orientation sensor 150, and transmits the pitch of tool 140 and the inclination of tool 140 to transceiver 120 by way of a wireless communication 165, i.e., by way of a wireless communication signal.

Transceiver 120 receives the pitch of tool 140 and the inclination of tool 140 from tool 140, by way of wireless communication 165, and forwards them to computer 105. Thus, computer 105 has the relative position of reflector 145, i.e., relative to reflector 130, the pitch of tool 140 and the inclination of tool 140.

During a trial mode of operation of system 100, user 170 moves tool 140 to a desired position, and computer 105 saves to a memory the relative position of reflector 145, the pitch of tool 140 and the inclination of tool 140, as a stored relative position of reflector 145, a stored pitch of tool 140 and a stored inclination of tool 140, respectively.

During a subsequent mode of operation of system 100, user 170 moves tool 140 to the vicinity of the desired position, and computer 105:
(a) determines a current relative position of reflector 145, and obtains a current pitch of tool 140 and a current inclination of tool 140;
(b) compares the current relative position of reflector 145, the current pitch of tool 140 and the current inclination of tool 140, to the stored relative position of reflector 145, the stored pitch of tool 140 and the stored inclination of tool 140, respectively; and
(c) provides, via user interface 110, an indication of whether the current relative position of reflector 145, the current pitch of tool 140 and the current inclination of tool 140, match the stored relative position of reflector 145, the stored pitch of tool 140 and the stored inclination of tool 140, respectively

The indication provided via user interface 110 can be in either or both of an audio form or a visual form. For example, for the audio indication, user interface 110 may include a speech synthesizer (not shown) and a speaker (not shown) and issue spoken commands to guide user 170 to mover tool 140 to the stored position, pitch and inclination. For example, for the visual indication, user interface 110 may present on or more graphs or images to guide user 170 to move tool 140 to the stored position, pitch and inclination.

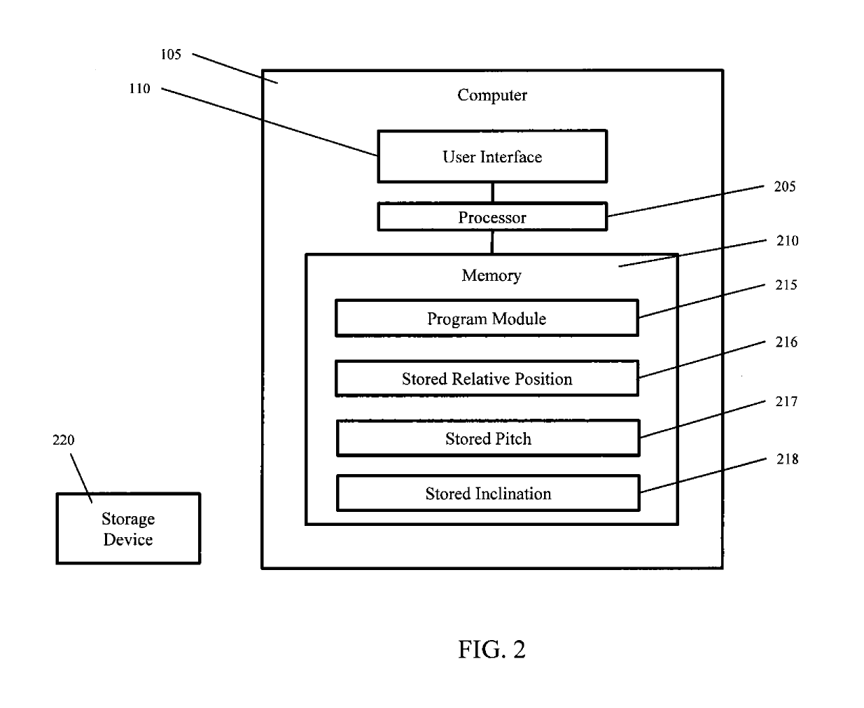

FIG. 2 is a block diagram of an embodiment of computer 105. Computer 105 includes user interface 110, as mentioned above, and further includes a processor 205 and a memory 210.

Processor 205 is an electronic device configured of logic circuitry that responds to and executes instructions. Operations that are described herein as being performed by computer 105 are more specifically performed by processor 205.

User interface 110 includes an input device, such as a keyboard or speech recognition subsystem, for enabling user 170 to communicate information and command selections to processor 205. User interface 110 also includes an output device such as a display or a printer, or a speech synthesizer. A cursor control such as a mouse, track-ball, or joy stick, allows user 170 to manipulate a cursor on the display for communicating additional information and command selections to processor 205.

Memory 210 is a tangible computer-readable storage medium encoded with a computer program. In this regard, memory 210 stores data and instructions that are readable and executable by processor 205 for controlling the operation of processor 205. Memory 210 also serves as a repository for the storage of the relative position of reflector 145, the pitch of tool 140 and the inclination of tool 140, in the form of a stored relative position 216, a stored pitch 217, and a stored inclination 218, respectively. Memory 210 may be implemented in a random access memory (RAM), a hard drive, a read only memory (ROM), or a combination thereof. One of the components of memory 210 is a program module 215.

Program module 215 contains instructions for controlling processor 205 to execute the operations of computer 105 described herein. The term “module” is used herein to denote a functional operation that may be embodied either as a stand-alone component or as an integrated configuration of a plurality of subordinate components. Thus, program module 215 may be implemented as a single module or as a plurality of modules that operate in cooperation with one another. Moreover, although program module 215 is described herein as being installed in memory 210, and therefore being implemented in software, it could be implemented in any of hardware (e.g., electronic circuitry), firmware, software, or a combination thereof

While program module 215 is indicated as already being loaded into memory 210, it may be configured on a storage device 220 for subsequent loading into memory 210. Storage device 220 is a tangible computer-readable storage medium that stores program module 215 thereon. Examples of storage device 220 include a compact disk, a magnetic tape, a read only memory, an optical storage media, a hard drive or a memory unit consisting of multiple parallel hard drives, and a universal serial bus (USB) flash drive. Alternatively, storage device 220 can be a random access memory, or other type of electronic storage device, located on a remote storage system and coupled to computer 105 via a network (not shown).

Components performing the functionalities of computer 105 and transceiver 120 need not be grouped as illustrated in FIG. 1. For example, processor 205 and memory 210 may be components of transceiver 120, or all of the functionalities of computer 105 and transceiver 120 may be included in one housing.

System 100 is can be employed in a variety of situations, with a variety of tools. An exemplary application is in the field of dentistry, where reflector 130 is situated on a dental appliance, and tool 140 is situated on a dental tool such as a dentist drill.

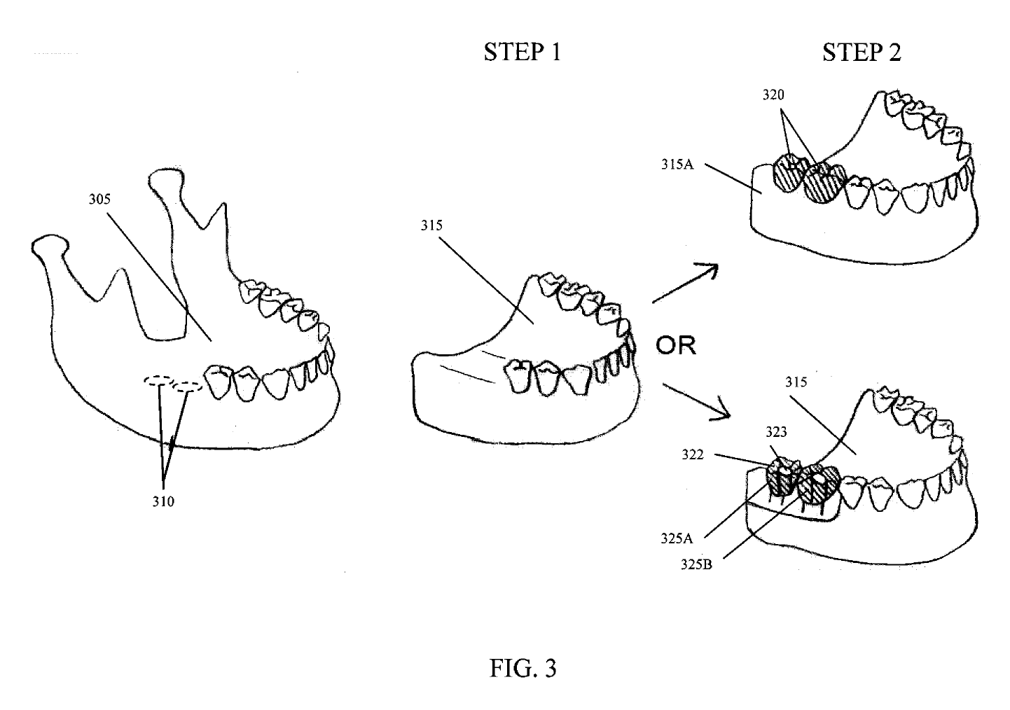

FIGS. 3-6 are illustrations of a dental procedure for a surgical placement of a dental implant, in which user 170 utilizes system 100. Steps of the dental procedure are designated as steps 1-6.

Referring to FIG. 3, there is shown a jaw 305 of a patient, i.e., the actual jaw of the patient, with missing lower right 1^{st} and 2^{nd} molars indicated by spaces 310 to be replaced with two implant restorations.

In step 1, user 107 creates a model 315, e.g., a stone cast model, by pouring an initial alginate impression of the patient's arch.

In step 2, user 170 either (a) sends model 315 to a dental lab, which produces a second stone cast model, i.e., a model 315A, which includes model teeth 320, i.e., a model of the teeth to be replaced, or (b) affixes two pre-fabricated teeth 325A and 325B to model 315 with sticky wax.

In a case where user 170 employs model 315A, user 170 will drill a channel through each of model teeth 320 to produce a channel that corresponds to a desired track for drilling for a dental implant. That is, user 170 will drill through each of model teeth 320 at a proper angle and inclination as if model 315A was jaw 305, i.e., the patient's actual jaw. The holes that are drilled into model teeth 320 are at the proper linear position and angular orientation to ensure proper placement of a future dental implant.

As noted above, instead of using model teeth 320, user 170 may use prefabricated teeth 325A and 325B. Prefabricated tooth 325A has a crown 322, i.e., a member having dimensions of a portion of a tooth that shows above a gum line, and a channel 323 that traverses crown 322 and will accommodate a bur of a dental drill to orient the bur during a dental procedure. Prefabricated tooth 325A is situated on model 315 such that channel 323 corresponds to a desired track for drilling for a dental implant. Prefabricated tooth 325B is constructed similarly to prefabricated tooth 325A.

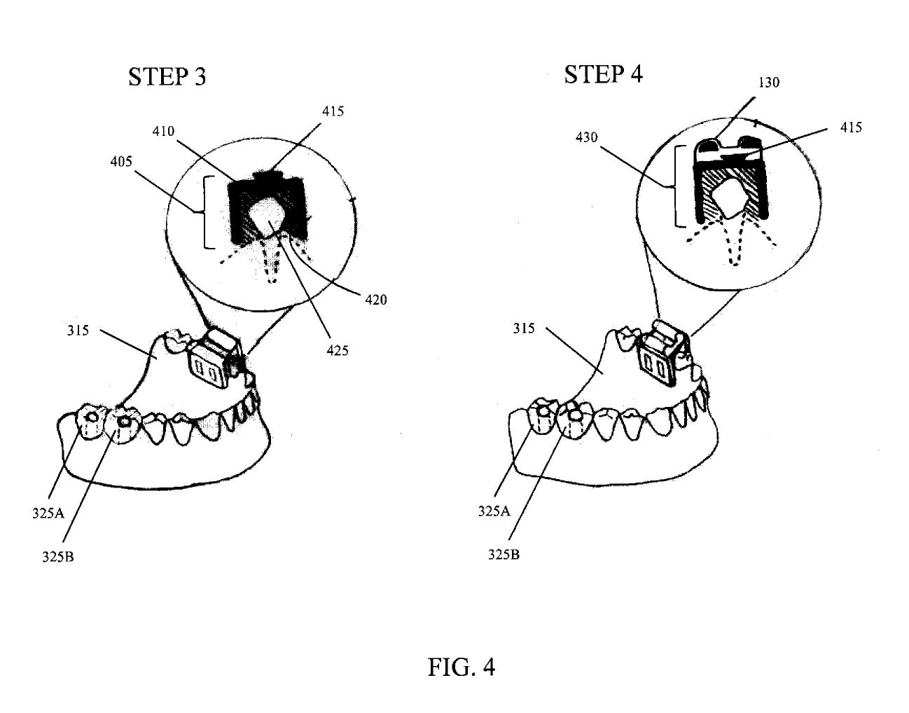

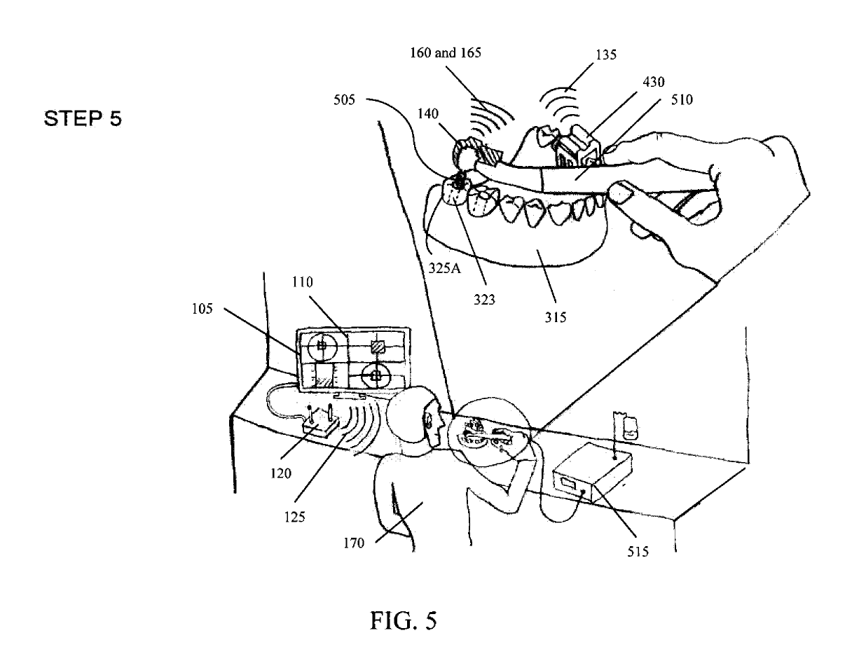

In FIGS. 4 and 5, for steps 3-5 of the procedure, we are presenting a case in which user 170 has opted to use prefabricated teeth 325A and 325B. However, in a case where user 170 is employing model 315A, in steps 3-5, user 170 will perform operations on model teeth 320 instead of prefabricated teeth 325A and 325B.

Refer to FIG. 4, in step 3, user 170, on model 315, positions a jig 405, i.e., a dental appliance, over a reference tooth 425, and takes an impression of reference tooth 425. Jig 405 is configured of a shell 410 that fits over reference tooth 425 and holds a material 420, i.e., a bite registration material, that forms the impression of reference tooth 425. Jig 405 also includes a member 415 for holding reflector 130.

Member 415 may be configured in the form of any suitable mechanism for holding reflector 130. For example, member 415 may be configured as a track onto which reflector 130 is slid, or a snap onto which reflector 130 is press fit. In FIG. 4, member 415 is shown as a track.

In step 4, user 170 mounts reflector 130 onto jig 405 by securing reflector 130 to member 415. A completed assembly of jig 405 with reflector 130 mounted thereon is referred to herein as a jig 430.

Note that jig 430 is on the same arch as prefabricated teeth 325A and 325B.

Refer to FIG. 5, in step 5, user 170 performs a trial operation during which system 100 will record (a) a position of reflector 145 relative to reflector 130, (b) a pitch of tool 140, and (c) an inclination of tool 140. Recall that reflector 130 is situated on jig 430, and reflector 145 is situated on tool 140. Here, tool 140 is, in turn, situated on a drill 510, i.e., a dentist drill, having a bur 505. Drill 510 is coupled to an implant motor 515.

The length of bur 505, as well as the length of the implant to be placed, is recorded into computer 105. With this information, computer 105 can calculate where the top, i.e., collar, of the implant should be, and therefore computer 105 can also calculate a measurement for depth. Computer 105 will also compensate for any physical offset or displacement between the positions of tool 140 and bur 505. For example, bur 505 may be regarded as an axis in a coordinate system, and the tip of bur 505 may be regarded as being at the origin of the coordinate system. Computer 105 will compensate for the displacement of reflector 145 from the axis and with respect to the tip of bur 505.

User 170 places bur 505 into channel 323 of prefabricated tooth 325A. Transceiver 120 emits signal 125, which is reflected by each of reflectors 130 and 145 in the form of reflected signals 135 and 160, respectively. Transceiver 120 receives reflected signals 135 and 160. Computer 105 determines, from reflected signals 135 and 160, a position of reflector 145 relative to reflector 130, i.e., the relative position of reflector 145.

Recall that tool 140 includes orientation sensor 150 and transceiver 155, and that orientation sensor 150 senses a pitch of tool 140 and an inclination of tool 140. Transceiver 155 transmits the pitch of tool 140 and the inclination of tool 140 via wireless communication 165. Transceiver 120 receives the pitch of tool 140 and the inclination of tool 140 from transceiver 155 via wireless communication 165. Computer 105 receives the pitch of tool 140 and the inclination of tool 140 from transceiver 120.

When user 170 is satisfied with the placement of bur 505, user 170 issues a command to computer 105, by way of user interface 110, for computer 105 to save the relative position of reflector 145, the pitch of tool 140 and the inclination of tool 140. Accordingly, computer 105 saves the relative position of reflector 145, the pitch of tool 140 and the inclination of tool 140 as stored relative position 216, stored pitch, and stored inclination, respectively.

The positional information of reflectors 130 and 145 is stored in computer 105, and can be replicated once requested by user 170. The positional information stored can be a series of numbers that represent the position and orientation of tool 140 or drill 510, or a rendition of tool 140 or drill 510, and model 315.

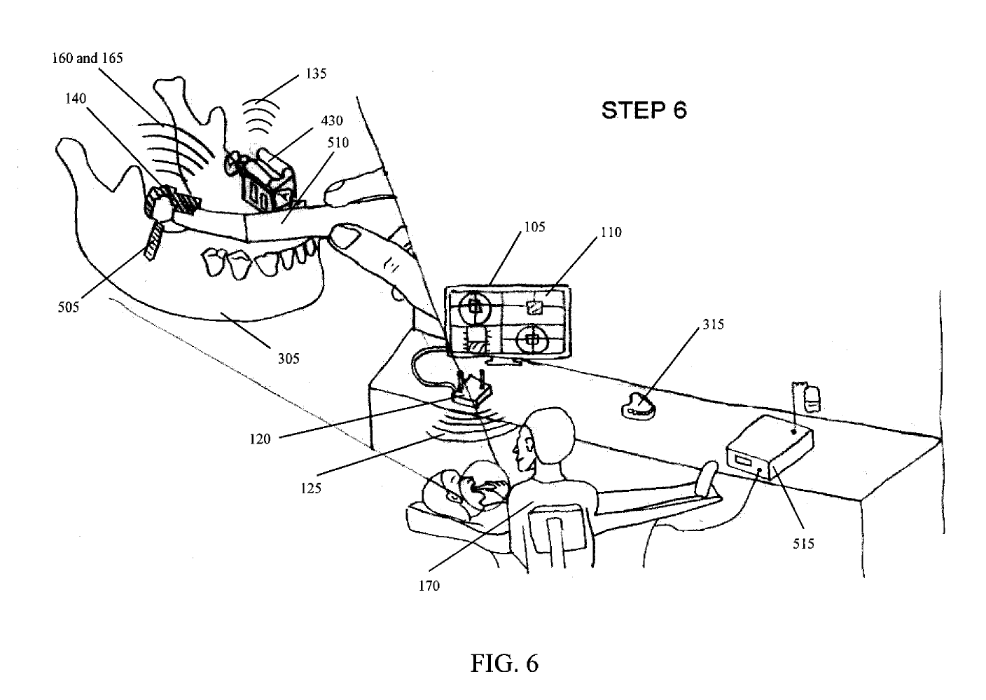

Refer to FIG. 6, in step 6, user 170 performs an actual, on-patient operation during which user 170 will replicate the placement of bur 505 that was recorded in step 5.

Recall that in step 3, user 170, on model 315, positioned jig 405 over a reference tooth 425, and took an impression of reference tooth 425, and that in step 4, user prepared jig 430 from jig 405. Thus, jig 430 contains the impression of reference tooth 425.

In step 6, user 170 moves jig 430 from model 315 to jaw 305, and more specifically, places jig 430 on the tooth of jaw 305 that corresponds to reference tooth 425 of model 315. Thus, jig 430 and reflector 130 will be situated on jaw 305 in a manner that is substantially identical to that of being situated on model 315. Accordingly, jig 430 will be situated on the same arch that will be receiving the implants. During step 6, system 100 will guide user 170 to position reflector 145 (and thereby position tool 140, and thus bur 505) to the same position, relative to reflector 130, as was recorded in step 5.

Prior to drilling the holes, with guidance being provided by system 100, user 170 reproduces the exact location of the bur 505 that recorded using model 315. Such guidance can be in the form of visual or auditory presentations or prompts from user interface 110 that inform user 170 of the proper placement of bur 505 in three-dimensional space. Once bur 505 is properly positioned and oriented, user 170 can perform the osteotomy.

User 170 places bur 505 in a vicinity of jaw 305 where user 170 expects to drill. Transceiver 120 emits signal 125, which is reflected by each of reflectors 130 and 145 in the form of reflected signals 135 and 160, respectively. Transceiver 120 receives reflected signals 135 and 160. Computer 105 determines, from reflected signals 135 and 160, a current position of reflector 145 relative to reflector 130, i.e., the current relative position of reflector 145.

Orientation sensor 150 senses a current pitch of tool 140 and a current inclination of tool 140. Transceiver 155 transmits the current pitch of tool 140 and the current inclination of tool 140 via wireless communication 165. Transceiver 120 receives the current pitch of tool 140 and the current inclination of tool 140 from transceiver 155 via wireless communication 165. Computer 105 receives the current pitch of tool 140 and the current inclination of tool 140 from transceiver 120.

Computer 105 (a) compares (i) the current relative position of reflector 145 to stored relative position 216, (ii) the current pitch of tool 140 to stored pitch 217, and (iii) the current inclination of tool 140 to stored inclination 218, and (b) provides, via user interface 110, an indication of whether (i) the current relative position of reflector 145 matches stored relative position 216, (ii) the current pitch of tool 140 matches stored pitch 217, and (iii) the current inclination of tool 140 matches stored inclination 218.

A match between the current relative position of reflector 145 and stored relative position 216 occurs when the current relative position of reflector 145 is within a predetermined tolerable distance, i.e., a predetermined tolerance, of stored relative position 216. A match between the current pitch of tool 140 and stored pitch 217 occurs when the current pitch of tool 140 is within a predetermined tolerable angle, i.e., a predetermined tolerance, of stored pitch 217. A match between the current inclination of tool 140 and stored inclination 218 occurs when the current inclination of tool 140 is within a predetermined minimal angle, i.e., a predetermined tolerance, of stored inclination 218. The tolerances can be any desired distance and angles that user 170 deems acceptable.

When each of (i) the current relative position of reflector 145 matches stored relative position 216, (ii) the current pitch of tool 140 matches stored pitch 217, and (iii) the current inclination of tool 140 matches stored inclination 218, this means that bur 505 is located and aligned as it was in step 5. Accordingly, user 170 can then activate implant motor 515 and proceed with drilling in jaw 305.

In summary, steps 4-6 of the dental procedure include:
(a) placing reflector 130 on model 315,
(b) performing a trial operation on model 315, using tool 140, which has reflector 145 and orientation sensor 150 situated thereon, where the trial operation includes:
   (1) transmitting signal 125,
   (2) receiving:
      (A) reflected signal 135 from a reflector 130, and
      (B) reflected signal 160 from reflector 145,
   (3) determining, from reflected signal 135 and reflected signal 160, a position of reflector 145 relative to reflector 130, thus yielding a relative position of reflector 145,
   (4) receiving from orientation sensor 150, a pitch of tool 140 and an inclination of tool 140, and
   (5) saving the relative position, the pitch and the inclination as stored relative position 216, stored pitch 217 and stored inclination 218, respectively, and
(c) performing an actual, on-patient operation on jaw 305 using tool 140, where the actual, on-patient operation includes:
   (1) moving reflector 130 from model 315 to a corresponding location on jaw 305,
   (2) transmitting signal 125,
   (3) receiving:
      (A) reflected signal 135, and
      (B) reflected signal 160,
   (4) determining, from reflected signal 135 and reflection 45, a current position of reflector 145 relative to reflector 130, thus yielding a current relative position of reflector 145,
   (5) receiving from orientation sensor 150, a current pitch of tool 140 and a current inclination of tool 140,
   (6) comparing the current relative position, the current pitch and the current inclination, to stored relative position 216, stored pitch 217 and stored inclination 218, respectively, and
   (7) providing, via user interface 110, an indication of whether the current relative position, the current pitch and the current inclination, match stored relative position 216, stored pitch 217 and stored inclination 218, respectively.

The benefits of performing steps 3-5 using model 315 or model 315A are several. First, each of models 315 and 315A is a completely unobstructed object from which to properly angle the drill. Preparation is simplified as not only is the opposing jaw absent, but models 315 and 315A are entirely exposed to view by not being enclosed in the mouth of the patient. Additionally, user 170 can work with model 315 or model 315A without the patient having to be present, and results, e.g., the position and orientation of bur 505, can be stored in computer 105 (e.g., John Smith, implant position #30) and recalled when necessary.

In the foregoing description of the dental procedure, steps3-5 were performed on model 315. However, steps 3-5 could, instead of being performed on model 315, be performed on the patient's jaw, i.e., jaw 305, or on a computer model, i.e., a virtual model.

Performing steps 3-5 on jaw 305 entails placing bur 505 in the patient's mouth to record the position of bur 505 during a non-moving, relaxed static environment. Thereafter, in step 6, when surgery begins, and the drilling environment becomes dynamic, i.e., drilling into the jaw bone is occurring, user 170 has the guidance of the pre-recorded position and 3-D spatial angulation/inclination provided by system 100.

To perform steps 3-5 on a computer model, user 170 situates jig 430 on a tooth on jaw 305, and takes a CT scan of jaw 305. Thereafter, user 170 conducts a trial surgery using implant surgical planning software, where an implant is placed in a virtual environment being presented on a computer. Spatial data, i.e., a computer file, regarding a position of the implant relative to reflector 130 is generated and sent to computer 105. Thereafter, in step 6, system 100 guides user 170 to position bur 505 in accordance with the spatial data.

If the patient has a removable partial denture that is currently replacing front teeth, an impression with the denture, and model 315 is obtained so that the teeth are in model 315. User 170 can then drill into model 315 and create a channel at a desired pitch, inclination, and depth on model 315. Again, that position is saved to computer 105 and subsequently recalled by user 170 to properly place drill 510 during the actual implantation procedure.

If a patient is completely edentulous, then a “temporary implant” is placed within the patient's jawbone, in a location that will not receive a permanent implant. The temporary implant will be used to house reflector 130. In order to get a model of this configuration, a simple impression of the temporary implant is taken, and the model is then prepared. Using a duplicate of the patient's denture, a trial osteotomy is carried out in a similar fashion as described above, and positions of reflectors 130 and 145 are obtained and recorded. Reflector 130 is then taken off the implant analog (temporary implant), and placed on a temporary one in the patient's mouth. Once all the actual osteotomies are carried out in the patient, and the permanent implants placed, the temporary implant is removed.

Although system 100 is described herein as being used for a dental osteotomy, it can be employed in any application, for example, other types of surgery, in which tool 140 needs to be positioned and aligned in a particular manner. Accordingly, rather than using a model of the patient's jaw, the procedure will use a model of some other appropriate part of the patient's anatomy, e.g., the patient's skull or eye socket.

System 100 is described herein as employing one reflector 130. However, system 100 can be configured with a plurality of reflectors 130, and determine the relative position of reflector 145 to each of the reflectors 130. Using a plurality of reflectors 130 and determining the relative position of reflector 145 to each of the reflectors 130 may increase accuracy of the ultimate measurement and placement of reflector 145.

The present document describes various items of information being communicated or processed. For example, computer 105 receives reflected signal 135 from transceiver 120, and then processes reflected signal 135. In actuality, it is not reflected signal 135 that is being communicated from transceiver 120 to computer 105, but instead, data, e.g., digital data, that represents reflected signal 135. Similarly, in the context of information being communicated or processed, reflected signal 160, and the pitch and inclination of tool 140 are in the form of data that represents reflected signal 160, and the pitch and inclination of tool 140.

Also, instead of employing jig 430 to hold reflector 130, a stent could be used, in place of jig 430, to hold reflector 130.

Additionally, tool 140 may be configured as either (a) a component that is fit onto drill 510, or (b) an integral component of drill 510.

Although system 100 is described herein as employing RADAR to measure the positions of reflectors 130 and 145, the method described herein is generally contemplated as being able to employ any technology that facilitates the measurement of the position of a tool, e.g., tool 140 relative to a reference object, e.g., reflector 130. For example, generally speaking, system 100 is employable in a medical procedure comprising:
(a) performing a first operation on a model of a feature of a patient, using a tool, wherein the first operation includes:
   (1) situating a reference object at a location on the model;
   (2) measuring a position of the tool relative to the reference object, thus yielding a relative position of the tool;
   (3) measuring a pitch of the tool and an inclination of the tool; and
   (4) saving the relative position, the pitch and the inclination as a stored relative position, a stored pitch and a stored inclination, respectively, and
(b) performing a second operation, on the patient, using the tool, wherein the second operation includes:
   (1) moving the reference object from the model to a location on the patient that corresponds to the location on the model;
   (2) measuring a current position of the tool relative to the reference object, thus yielding a current relative position of the tool;
   (3) measuring a current pitch of the tool and a current inclination of the tool;
   (4) comparing the current relative position, the current pitch and the current inclination, to the stored relative position, the stored pitch and the stored inclination, respectively; and
   (5) providing, via a user interface, an indication of whether the current relative position, the current pitch and the current inclination, match the stored relative position, the stored pitch and the stored inclination, respectively.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

1. A method comprising:
transmitting a signal;
receiving (a) a first reflection of said signal from a first reflector on a dental appliance, and (b) a second reflection of said signal from a second reflector on a dental tool; and
determining, from said first reflection and said second reflection, a position of said second reflector relative to said first reflector, thus yielding a relative position of said second reflector.

2. The method of claim 1, further comprising:
receiving a pitch of said dental tool and an inclination of said dental tool.

3. The method of claim 2, further comprising:
storing, to a memory, said relative position, said pitch and said inclination.

4. The method of claim 2, further comprising:
comparing said relative position, said pitch and said inclination, to a stored relative position, a stored pitch and a stored inclination, respectively; and
providing, via a user interface, an indication of whether said relative position, said pitch and said inclination, match said stored relative position, said stored pitch and said stored inclination, respectively.

5. A system comprising:
a dental appliance having a first reflector;
a dental tool having a second reflector;
a transceiver that:
transmits a signal;
receives (a) a first reflection of said signal from said first reflector, and (b) a second reflection of said signal from said second reflector; and
a processor that is communicatively coupled to said transceiver, and determines, from said first reflection and said second reflection, a position of said second reflector relative to said first reflector, thus yielding a relative position of said second reflector.

6. The system of claim 5,
wherein said dental tool also includes:
an orientation sensor that senses a pitch of said dental tool and an inclination of said dental tool; and
a transmitter that transmits said pitch and said inclination by way of a wireless communication, and
wherein said transceiver also receives said pitch and said inclination by way of said wireless communication.

7. The system of claim 6, further comprising:
a memory, wherein said processor stores, to said memory, said relative position, said pitch and said inclination.

8. The system of claim 6,
wherein said dental tool is a drill having a bur, and
wherein said system further comprises a prefabricated tooth having:
a crown; and
a channel that traverses said crown and accommodates said bur to orient said bur during a dental procedure.

9. The system of claim 6, further comprising a user interface, wherein said processor also:
compares said relative position, said pitch and said inclination, to a stored relative position, a stored pitch and a stored inclination, respectively; and
provides, via a user interface, an indication of whether said relative position, said pitch and said inclination, match said stored relative position, said stored pitch and said stored inclination, respectively.

10. The system of claim 5,
wherein said dental appliance comprises a shell that fits over a tooth and holds a material that forms an impression of said tooth; and
wherein said first reflector is situated on said shell.

11. A storage device comprising instructions that are readable by a processor and cause said processor to:
communicate with a transceiver that transmits a signal;
receive, from said transceiver, (a) a first reflection of said signal from a first reflector on a dental appliance, and (b) a second reflection of said signal from a second reflector on a dental tool; and
determine, from said first reflection and said second reflection, a position of said second reflector relative to said first reflector, thus yielding a relative position of said second reflector.

12. The storage device of claim 11, wherein said instructions also cause said processor to:
receive, from said transceiver, a pitch of said dental tool and an inclination of said dental tool.

13. The storage device of claim 12, wherein said instructions also cause said processor to:
store, to a memory, said relative position, said pitch and said inclination.

14. The storage device of claim 12, wherein said instructions also cause said processor to:
compare said relative position, said pitch and said inclination, to a stored relative position, a stored pitch and a stored inclination, respectively; and
provide, to a user interface, an indication of whether said relative position, said pitch and said inclination, match said stored relative position, said stored pitch and said stored inclination, respectively.

15-34. (canceled)
